(19) United States
(12) Patent Application Publication
(10) Pub. No.: US 2024/0318101 A1
(43) Pub. Date: Sep. 26, 2024

(54) Dishwashing Machine Cleaning Composition

(71) Applicant: Reckitt Benckiser Finish B.V, Hoofddorp (NL)

(72) Inventors: Souhila AISSANI, Heidelberg (DE); Natalia FRAGOSO, Heidelberg (DE); Patrick lLLERT, Heidelberg (DE); Danuta KUZMICZ, Heidelberg (DE); Helena BAIERLE, Heidelberg (DE); William WHITTAKER, Heidelberg (DE)

(21) Appl. No.: 18/554,306

(22) PCT Filed: Mar. 31, 2022
(86) PCT No.: PCT/EP2022/058589

§ 371 Date: Oct. 6, 2023

(30) Foreign Application Priority Data
Apr. 7, 2021 (GB) 2104909.3

(51) Int. Cl. C11D 3/386; A47L 15/00; A47L 15/42; C11D 1/825

(52) U.S. Cl. CPC C11D 3/38618; A47L 15/0007; A47L 15/4208; C11D 1/8255; C11D 3/38645; C11D 2111/14

(57) ABSTRACT

The present invention relates to a dishwashing machine cleaning composition for cleaning one or more components of a dishwashing machine comprising an enzyme system comprising at least one cellulase, and at least one amylase; wherein the composition has a pH of between 4 and 6, and wherein the composition is substantially free of any pectinase. The invention also relates to a method for cleaning one or more components of a dishwashing machine, such as the filter. The invention further relates to a use of the dishwashing machine cleaning composition for cleaning one or more components of a dishwashing machine, preferably the filter.

The present invention relates to a dishwashing machine cleaning composition for cleaning one or more components of a dishwashing machine, to a method for cleaning one or more components of a dishwashing machine, and to the use of the composition for cleaning one or more components of a dishwashing machine.

### BACKGROUND

Automatic dishwashing (ADW) machines commonly have a filter built in to capture soils. It prevents them from being redistributed around the interior of the dishwashing machine during the washing and/or rinsing cycles.

Typically, these filters capture soils having a size of about, or greater than about, 1 mm. Users should remove and clean the filter frequently in order to prevent the build-up of soils on the filter, which can lead to malodours and less efficient performance of the filter and ultimately the dishwashing machine. However, many dishwashing machine users do not do this and so the captured soil particles remain on the filter. Some soil particles will be washed away over time, but others will remain on the filter and decay, and can cause bad odours. In addition to the formation of bad odours, soil particles may clog the filter. This may cause problems with the circulation of the wash and rinse waters leading to poor cleaning results.

Dishwashing machine users typically associate a dirty filter with the dishwashing being dirty and then belief in the ability of the machine to adequately clean their kitchenware is reduced. It is evident to the dishwashing machine users that the filter is dirty as it is typically readily visible.

However, if the filter of the dishwashing machine is not cleaned frequently, the soils present may become harder to remove, further increasing the consumer's reluctance to do so. They may also become more malodorous over time and eventually the performance of the dishwashing machine may be impaired.

The types of soils which are typically found in the filter are greasy, proteinaceous, and fibrous/cellulosic type residues. Whilst such residues can be rinsed out of the dishwashing machine once they have a sufficiently small size to pass through the dishwashing machine filter, they cannot be easily dissolved or otherwise removed without manual intervention.

Most conventional dishwasher machine cleaners are based on organic acids and surfactants to treat limescale deposits and grease build-up. However, such commercial compositions are not very effective at cleaning vegetable or organic soils from the interior of the dishwashing machine (e.g. from the filters). This vegetable organic soil can be digested by specific enzymes. The normal dishwashing enzymes are unstable or ineffective at such low pH to allow also a good limescale removal performance.

Machine cleaning tablets, e.g. for use in automatic dishwashers, are known from e.g. US 2003/0032568 which discloses compositions comprising lime-scale remover acid, non-ionic surfactants, and certain types of detergency enzyme.

Filter cleaning compositions for automatic dishwashing machines are also known from WO 2007/066111. The compositions disclosed therein comprise at least one non-starch carbohydrase, such as a cellulase.

Machine cleaning compositions are also known from WO 2011/161459. The compositions disclosed therein comprise at least one cellulase and at least one pectinase. Enzymes such as pectinases only tackle certain type of soils.

Therefore, there is a need in the art to provide a composition which provides effective removal of consumer-relevant types of stains and soils from the interior of the dishwashing machine (e.g. from the filter). In particular, of proteinaceous stains, fibrous/cellulosic soils, and amylase-based stains.

Furthermore, there is also a need to provide such a composition which further provides good lime-scale removal.

It is an object of the present invention to address at least one of the above-referenced problems.

In particular the present invention seeks to provide a composition which provides effective removal of several types of stains and soils from the interior of the dishwashing machine (e.g. from the filter), in particular of greasy soils, proteinaceous soils, fibrous/cellulosic soils, and amylase-based stains, which are consumer-relevant types of stains and soils. The composition also provides lime scale removal from the interior of the dishwashing machine, for example, the filter. It is still a further aim to provide such compositions which can be used when the dishwashing machine is undergoing a loaded or unloaded washing cycle. It is yet a further aim to provide such compositions which can be used when the dishwashing machine is not being used, that is, as a leave-on treatment between dishwashing machine cycles.

### SUMMARY OF THE INVENTION

In a first aspect, the present invention relates to a dishwashing machine cleaning composition for cleaning one or more components of a dishwashing machine comprising an enzyme system comprising:
at least one cellulase, and
at least one amylase
   wherein the composition has a pH of between 4 and 6, and wherein the composition is substantially free of any pectinase.

In an embodiment, the at least one cellulase is present in an amount of between 0.001 wt. % and 2 wt. % of active cellulase, based on the total weight of the composition; preferably between 0.005 wt. % and 1.5 wt. %, more preferably between 0.01 wt. % and 1 wt. %, even more preferably between 0.025 wt. % and 0.25 wt. %.

In an embodiment, the at least one amylase is present in an amount of between 0.0001 wt. % and 2 wt. % of active amylase, based on the total weight of the composition, preferably between 0.0005 wt. % and 1 wt. %, more preferably between 0.001 wt. % and 0.5 wt. %, even more preferably between 0.0025 wt. % and 0.05 wt. %.

In another embodiment, the enzyme system further comprises at least one protease.

In an embodiment, the enzyme system consists of:
at least one cellulase,
at least one amylase, and
at least one protease.

In a preferred embodiment, the at least one protease is present in an amount of between 0.005 wt. % and 5 wt. % of active protease, based on the total weight of the composition, preferably between 0.01 wt. % and 2.5 wt. %, more preferably between 0.025 wt. % and 1 wt. %, even more preferably between 0.05 wt. % and 0.75 wt. %.

In a preferred embodiment, the dishwashing machine cleaning composition has a pH of between 4.5 and 5.5.

In an embodiment, the dishwashing machine cleaning composition further comprises at least one non-ionic surfactant, preferably selected from the group consisting of alkoxylated alcohols, more preferably selected from the group consisting of ethoxylated alcohols, propoxylated alcohols, ethoxylated/propoxylated alcohols, and mixtures thereof, even more d alcohols, propoxylated alcohols, ethoxylated/proproxylated alcohols, and minutes thereof, in which the alkyl chain of the surfactant has between 10 and 18 carbon atoms, preferably between 12 and 16 carbon atoms, more preferably between 12 and 14 carbon atoms.

In a preferred embodiment, the dishwashing machine cleaning composition is in liquid form and comprises at least 1 wt. % water, based on the total weight of the composition, preferably at least 10 wt. %, more preferably at least 20 wt. %, even more preferably at least 50 wt. %, most preferably at least 60 wt. %.

In an embodiment, the dishwashing machine cleaning composition comprises at least one thickener and/or at least one builder.

In a preferred embodiment, the dishwashing machine cleaning composition is a dishwashing machine filter cleaning composition.

In a second aspect, the invention relates to a method for cleaning one or more components of a dishwashing machine, preferably the filter, comprising the following steps:
a) Providing the composition according to the first aspect of the invention;
b) Contacting at least part of the one or more components of the dishwashing machine to be cleaned with the composition according to the first aspect of the invention;
c) Adding water until the one or more components of the washing machine to be cleaned are at least partially or completely covered with the water;
d) Waiting for a period of between 1 h to 48 h, preferably between 3 h to 36 h, more preferably between 6 h to 24 h, even more preferably between 12 h to 24 h; and
e) Performing a wash cycle in the dishwashing machine, with the one or more components to be cleaned located in the dishwashing machine.

In one embodiment, the amount of composition according to the first aspect of the invention that is provided in step a) and applied in step b) is between 10 g and 1000 g, preferably between 50 g and 750 g, more preferably between 75 g and 500 g, even more preferably between 100 g and 250 g.

In one embodiment, the method comprises steps d.1) and d.2) which are performed before step e), comprising:
d. 1) Loading the dishwashing machine with kitchenware to be cleaned,
d.2) Adding a dishwashing detergent to the dishwashing machine.

In a preferred embodiment, the one or more components of the dishwashing machine to be cleaned remain in the machine during one or more of the steps a) to e), preferably the one or more components remain in the machine during all steps a) to e).

In a third aspect, the invention relates to a use the composition according to the first aspect of the invention for cleaning one or more components of a dishwashing machine, preferably the filter.

### Definitions

The following definitions are used in the present application.

“Cellulases” as used in the present application means: class of enzymes that catalyse the cellylolysis or hydrolysis of cellulose.

“Amylases” as used in the present application means: class of enzymes that catalyse the hydrolysis of starch into sugars such as glucose and maltose.

“Proteases” as used in the present application means: class of enzymes that catalyse the breakdown of proteins into smaller polypeptides or single amino acids.

“Licheninase” as used in the present application means: class of enzymes that catalyse the hydrolysis of (1,4)-β-D-glucosidic linkages in ß-D-glucans containing (1,3) and (1,4)-bonds.

### DETAILED DESCRIPTION OF THE INVENTION

In a first aspect, the present invention relates to a dishwashing machine cleaning composition for cleaning one or more components of a dishwashing machine comprising an enzyme system comprising:

at least one cellulase, and
at least one amylase

wherein the composition has a pH of between 4 and 6, and wherein the composition is substantially free of any pectinase.

By substantially free of any pectinase is meant that no pectinase is intentionally added to the composition. In an embodiment, the composition comprises less than 0.005 wt. % of active pectinase, based on the total weight of the composition, preferably less than 0.001 wt. %, more preferably less than 0.0005 wt. %, even more preferably less than 0.0001 wt. %, most preferably the composition is free of any pectinase.

Compositions known in the art comprise enzymes such as pectinases; however, the present inventors have observed that the combination of cellulases and amylase enables the removal of all or almost all consumer-relevant stains and soils from the interior of a dishwashing machine, in particular from the filter.

In addition, it is believed that greasy soils or mineral deposits on the metallic surface of e.g. the filter may be prohibiting the enzymes to work properly.

The composition according to the invention provides excellent removal of soils from components of a dishwashing machine, in particular, the filter, thanks to the synergistic effect between the enzyme system and a pH of between 4 and 6. At this acidic pH, greasy soils or mineral deposits on the metallic surface of, e.g. the filter, are removed and the at least one cellulase and at least one amylase have excellent functionality. This leads to a dishwashing machine or machine component that is clean.

All compositions of the invention may be produced by any suitable method of preparation as well known in the art.

### Enzymes

Any cellulase which is suitable for use in automatic dishwashing applications may be used according to the present invention. Examples of commercially available cellulases include Celluzyme® produced by Novozymes, Accelerase® produced by Merck, Carezyme® produced by Novozymes, Puradax® produced by Genencor, Celluclast® produced by Novozymes, and Ecostone® produced by AB Enzymes.

The dishwashing machine cleaning composition comprises at least one cellulase, which may be present in an amount of between 0.001 wt. % and 2 wt. % of active cellulase, based on the total weight of the composition; preferably between 0.005 wt. % and 1.5 wt. %, more preferably between 0.01 wt. % and 1 wt. %, even more preferably between 0.025 wt. % and 0.25 wt. %.

When the composition according to the invention comprises between 0.025 wt. % and 0.25 wt. % of active cellulase, it provides excellent cleaning of the dishwashing machine or its components.

Any amylase which is suitable for use in automatic dishwashing applications may be used according to the present invention. Examples of commercially available amylases include Sainzyme® produced by Novozymes, Natalase® produced by Novozymes, Termamyl® produced by Novozymes, Solvay amylase, produced by Solvay, Amplify® produced by Novozymes. Especially suitable amylases are Stainzyme Plus 12 L and Amplify® Plus produced by Novozymes.

The dishwashing machine cleaning composition comprises at least one amylase, which may be present in an amount of between 0.0001 wt. % and 2 wt. % of active amylase, based on the total weight of the composition, preferably between 0.0005 wt. % and 1 wt. %, more preferably between 0.001 wt. % and 0.5 wt. %, even more preferably between 0.0025 wt. % and 0.05 wt. %.

The enzyme system may further comprise at least one protease. The present inventors have observed that by adding a protease to the enzyme system, the performance of the composition is improved, providing better cleaning of the machine or its components.

In an embodiment, the enzyme system consists of:
at least one cellulase,
at least one amylase, and
at least one protease.

Any protease which is suitable for use in automatic dishwashing applications may be used according to the present invention. Examples of commercially available proteases include those produce by Novozymes: Alcalase®, Durazym®, Esperase®, Everlase®, Flavourzyme®, Neutrase®, Prtamex™, Savinase®, Porafect®, Properase®, Blaze®, and Excellase®, Evity®. Especially suitable proteases are Evity 32 L and Blaze Supreme produced by Novozymes.

When the enzyme system comprises at least one protease or the enzyme system consists of at least one cellulase, at least one amylase and at least one protease, the protease may be present in an amount of between 0.005 wt. % and 5 wt. % of active protease, based on the total weight of the composition, preferably between 0.01 wt. % and 2.5 wt. %, more preferably between 0.025 wt. % and 1 wt. %, even more preferably between 0.05 wt. % and 0.75 wt. %.

In a preferred embodiment, the invention relates to a dishwashing machine cleaning composition for cleaning one or more the components of the dishwashing machine comprising an enzyme system consisting of:
at least one cellulase being present in an amount of between 0.001 wt. % and 2 wt. % of active cellulase, based on the total weight of the composition; preferably between 0.005 wt. % and 1.5 wt. %, more preferably between 0.01 wt. % and 1 wt. %, even more preferably between 0.025 wt. % and 0.25 wt. %;
at least one amylase being present in an amount of between 0.0001 wt. % and 2 wt. % of active amylase, based on the total weight of the composition, preferably between 0.0005 wt. % and 1 wt. %, more preferably between 0.001 wt. % and 0.5 wt. %, even more preferably between 0.0025 wt. % and 0.05 wt. %; and
at least one protease being present in an amount of between 0.005 wt. % and 5 wt. % of active protease, based on the total weight of the composition, preferably between 0.01 wt. % and 2.5 wt. %, more preferably between 0.025 wt. % and 1 wt. %, even more preferably between 0.05 wt. % and 0.75 wt. %;
   wherein the composition has a pH of between 4 and 6.

### pH Modifier

The composition according to the invention may also comprise a pH modifier, i.e. a source of acidity or a source of alkalinity, to obtain the desired pH. A source of acidity may be any suitable acidic compound, for example, a polycarboxylic acid. For example, a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity. Materials commonly used as a source of alkalinity are NaOH (sodium hydroxide), and Tri-Di- or Monoethanolamine; whilst sulfuric acid and citric acid are commonly used as a source of acidity. Conventional amounts of the alkalinity or acidity source may be used. Preferably, the source of acidity is citric acid.

For example, the dishwashing machine cleaning composition according to the invention may comprise between 0.5 wt. % and 10 wt. % of a pH modifier, based on the total weight of the composition, for example between 0.5 wt. % and 5 wt. %.

The dishwashing machine cleaning compositions may have a pH of between 4.5 and 5.5.

The pH in the composition is measured at 20° C. It will be understood that the composition is not diluted for measuring the pH.

It should be noted that the present inventors have observed that the pH influences the efficacy of the composition. For example, at a pH higher than approximately 6 and lower than approximately 4, the performance of the formulation decreases, i.e. the cleaning of the automatic dishwashing machine or its components is negligible. Furthermore, the inventors have observed that activity of the enzymes is the best within a pH ranging from between 4 to 6, preferably between 4.5 and 5.5.

### Surfactants

The dishwashing machine cleaning composition according to the invention may further comprise one or more surfactants. Suitable surfactants include non-ionic, cationic or amphoteric surfactants, or mixtures thereof and these are preferably included in the aforementioned amounts. Low foaming non-ionic surfactants are especially preferred. Many such surfactants are described in Kirk Othmer's Encyclopaedia of Chemical Technology, 3rd Ed., Vol. 22, pp. 360-379, “Surfactants and Detersive Systems”. Non-ionic surfactants are especially preferred according to the invention.

An especially preferred class of non-ionic surfactants according to the present invention are alkoxylated non-ionic surfactants, including alkoxylated alcohols, such as alkoxylated fatty alcohols. Examples of this type of surfactants are ethoxylated non-ionic surfactants and mixed alkoxylated non-ionic surfactants such as those having a mixture of EO/PO or BU/PO units etc.

The dishwashing machine cleaning composition according to the invention may comprise at least one non-ionic surfactant, preferably selected from the group consisting of alkoxylated alcohols, more preferably selected from the group consisting of ethoxylated alcohols, propoxylated alcohols, mixed ethoxylated/propoxylated alcohols, and mixtures thereof, even more preferably ethoxylated alcohols, propoxylated alcohols, mixed ethoxylated/proproxylated alcohols, and minutes thereof, in which the alkyl chain of the surfactant has between 10 and 18 carbon atoms, preferably between 12 and 16 carbon atoms, more preferably between 12 and 14 carbon atoms.

The at least one non-ionic surfactant may the formula have R¹(OCH₂CH₂)ₘ(O(CH₃)CHCH₂)ₙOH; wherein R¹ is an aliphatic hydrocarbon radical containing between 10 and 18 carbon atoms, preferably between 12 and 16 carbon atoms, more preferably between 12 and 14 carbon atoms; m has an average value of from 1 to 10, preferably between 1 to 5, more preferably 5; n has an average value of from 1 to 10, preferably between 1 to 5, more preferably 4. An especially suitable non-ionic surfactant is Marlox MO 154 produced by Sasol.

In one embodiment, the invention relates to a dishwashing machine composition comprising at least 0.001 wt. % of at least one non-ionic surfactant, based on the total weight of the composition, preferably between 0.005 wt. % and 10 wt. %, more preferably between 0.01 wt. % and 7.5 wt. %, even more preferably between 0.5 wt. % and 5 wt. %.

For example, the dishwashing machine composition may comprise at least 0.001 wt. % of at least one non-ionic surfactant, based on the total weight of the composition, preferably between 0.005 wt. % and 10 wt. %, more preferably between 0.01 wt. % and 7.5 wt. %, even more preferably between 0.5 wt. % and 5 wt. %; wherein preferably, the at least one non-ionic surfactant has the formula R¹(OCH₂CH₂)ₘ(O(CH₃)CHCH₂)ₙOH; wherein R¹ is an aliphatic hydrocarbon radical containing between 10 and 18 carbon atoms, preferably between 12 and 16 carbon atoms, more preferably between 12 and 14 carbon atoms; m has an average value of from 1 to 10, preferably between 1 to 5, more preferably 5; n has an average value of from 1 to 10, preferably between 1 to 5, more preferably 4. This type of non-ionic surfactants is especially preferred as it helps solubilising any non-water-soluble components in the composition, such as fragrances.

### Builders

It is preferred that the dishwashing machine cleaning composition further comprises at least one builder. The compositions may comprise conventional amounts of detergent builders which may be either phosphorous based or non-phosphorous based, or a combination of both types. Suitable builders are well known in the art.

If phosphorous containing builders are to be used, it is preferred that mono-phosphates, di-phosphates, tri-polyphosphates, polyphosphonates or oligomeric-poylphosphates are used. The alkali metal salts of these agents are preferred, in particular the sodium salts. An especially preferred phosphorous containing builder is sodium tripolyphosphate (STPP).

The non-phosphorous containing builder may be organic molecules with carboxylic group(s), amino acid based compounds, a succinate based compound or a mixture thereof.

Builder compounds which are organic molecules selected from water-soluble monomeric polycarboxylic acids and/or their acid forms may be used according to the invention. Suitable polycarboxylic acids include acyclic, alicyclic, heterocyclic and aromatic carboxylic acids. Suitable examples of such compounds include citric acid, fumaric acid, tartaric acid, maleic acid, lactic acid, (ethylenedioxy)diacetic acid, tartronic acid, lactic acid, glycolic acid, malonic acid, diglycolic acid and fumaric acid and salts and derivatives thereof, especially the water soluble salts thereof. Preferred salts of the above-mentioned compounds are the ammonium and/or alkali or alkaline earth metal salts, e.g. the ammonium, lithium, sodium, potassium or calcium salts, and particularly preferred salts are the sodium salts. These acids may be used in their monomeric or oligomeric form. An especially preferred builder is sodium citrate.

Preferred examples of amino acid based compounds according to the invention are MGDA (methyl-glycine-diacetic acid, and salts and derivatives thereof) and GLDA (glutamic-N,N-diacetic acid) and salts and derivatives thereof. A preferred MGDA compound is a salt of methyl glycine diacetic acid. Suitable salts include the triammonium salt, the tripotassium salt and, preferably, the trisodium salt. A preferred GLDA compound is a salt of glutamic diacetic acid. Suitable salts include the tetraammonium salt, the tetrapotassium salt and, preferably, the tetrasodium salt. Especially preferred are the sodium salts thereof.

In a preferred embodiment, the dishwashing machine cleaning composition comprises at least one builder selected from the group consisting of methyl-glycine-diacetic acid (MGDA), and salts and derivatives thereof, glutamic-N,N-diacetic acid (GLDA) and salts and derivatives thereof, trisodium citrate, and combinations thereof; wherein preferably, the composition comprises between 0.5 wt. % and 20 wt. % of the at least one builder, based on the total weight of the composition, preferably between 0.75 wt. % and 15 wt. %, more preferably between 1 wt. % and 12 wt. %, even more preferably between 5 wt. % and 10 wt. %.

### Chelating Agents

The dishwashing machine cleaning composition according to the invention may further comprise one or more chelating agents. Useful chelating agents are preferably selected from 1-hydroxyethylidene-I, 1-diphosphonic acid (HEDP), ethylenediamine disuccinic acid (EDDS), ethylenediaminetetraacetic acid (EDTA), diethylenetriaminepentaacetic acid (DTPA), diethylenetriaminepentamethylene phosphonic acid (DTPM PA), nitrilotriacetic acid (NTA), aspartic acid diethoxysuccinic acid (AES), aspartic acid-N,N-diacetic acid (ASDA), ethylenediamine tetra methylene phosphonic acid (EDTMP), iminodifumaric (IDF), iminoditartaric acid (IDT), iminodimaleic acid (IDMAL), iminodimalic acid (IDM), ethylene-diaminedifumaric acid (EDDF), ethylene-diaminedimalic acid (EDDM), ethylene-diamineditartaric acid (EDDT), ethylenediaminedimaleic acid and (EDDMAL), amino-tri(methylenephosphonic acid) (ATMP); and salts and mixtures thereof. Where any chelating agent described herein is present as a salt, it may be present as a metal salt, for example an alkali metal salt, or it may be present as an ammonium or quaternary ammonium salt. Suitable metal salts include salts or potassium, sodium, boron, magnesium, zinc or a mixture thereof. Especially preferred are sodium salts. Suitable ammonium salts include salts of ammonia and ethanolamine.

### Thickener

It is preferred that the dishwashing machine cleaning composition further comprises at least one thickener. Conventional thickeners include carbomers, xanthan gum and derivatives thereof, agar agar, gelatine, polyvinylpyrrolidone (PVP), polyethylene glycol (PEG), maltodextrin, cellulose ethers, hydroxyethylcellulose, ASE thickeners (alkali-swellable emulsion), HASE thickeners (hydrophobically modified alkali-swellable emulsion) and HEUR thickeners (hydrophobically modified ethylene oxide-based urethane).

In a preferred embodiment, the dishwashing machine cleaning composition comprises between 0.01 wt. % and 5 wt. % of at least one thickener, based on the total weight of the composition, preferably between 0.05 wt. % and 2.5 wt. %, more preferably between 0.1 wt. % and 1 wt. %, even more preferably between 0.25 wt. % and 0.75 wt. %; wherein preferably the at least one thickener is xanthan gum.

In a preferred embodiment, the dishwashing machine cleaning composition comprises between 0.5 wt. % and 20 wt. % of the at least one builder, based on the total weight of the composition, preferably between 0.75 wt. % and 15 wt. %, more preferably between 1 wt. % and 12 wt. %, even more preferably between 5 wt. % and 10 wt. %; and/or between 0.01 wt. % and 5 wt. % of at least one thickener, based on the total weight of the composition, preferably between 0.05 wt. % and 2.5 wt. %, more preferably between 0.1 wt. % and 1 wt. %, even more preferably between 0.25 wt. % and 0.75 wt. %.

### Additives

The composition may comprise additives such as dispersing polymers, fragrances, dyes, preservatives, and combinations thereof.

The dispersing polymers may be preferably at least partially neutralized or alkali metal, ammonium or substituted ammonium (e.g., mono-, di- or triethanolammonium) salts of polycarboxylic acids. The alkali metal, especially sodium salts are most preferred.

Other examples of dispersant polymers include unsaturated monomeric acids that can be polymerized to form suitable dispersant polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than 50 percent by weight of the dispersant polymer.

Copolymers of acrylamide and acrylate having a molecular weight of from 3,000 to 100,000, preferably from 4,000 to 20,000, and an acrylamide content of less than 50 percent, preferably less than 20 percent, by weight of the dispersant polymer can also be used.

Other examples of dispersant polymers are low molecular weight modified polyacrylate copolymers.

The compositions may include a preservative. Exemplary preservatives which may form part of the composition include useful water soluble or water dispersible compositions which include, sorbates, terpenes and parabens, including potassium sorbate, methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof.

The dishwashing machine cleaning composition is preferably an aqueous composition. Therefore, the composition may be in liquid form and it may comprise at least 1 wt. % water, based on the total weight of the composition, preferably at least 10 wt. %, more preferably at least 20 wt. %, even more preferably at least 50 wt. %, most preferably at least 60 wt. % or at least 70 wt. % or at least 80 wt. %. For example, the composition may comprise between 50 wt. % and 95 wt. % of water, based on the total weight of the composition, preferably between 60 wt. % and 90 wt. %, more preferably between 65 wt. % and 85 wt. %.

Liquid will be understood as a substance with a definite volume but no fixed shape, which flows freely. It includes, for example, viscous or thickened liquids and dispersions having a continuous liquid phase, which macroscopically behave like liquids.

In a preferred embodiment, the composition is a dishwashing machine filter cleaning composition.

In a second aspect, the invention relates to a method for cleaning one or more components of a dishwashing machine, preferably the filter, comprising the following steps:
a) Providing the composition according to the first aspect of the invention;
b) Contacting at least part of the one or more components of the dishwashing machine to be cleaned with the composition according to the first aspect of the invention;
c) Adding water until the one or more components of the washing machine to be cleaned are at least partially or completely covered with the water;
d) Waiting for a period of between 1 h to 48 h, preferably between 3 h to 36 h, more preferably between 6 h to 24 h, even more preferably between 12 h to 24 h; and
e) Performing a wash cycle in the dishwashing machine, with the one or more components to be cleaned located in the dishwashing machine.

It will be understood that steps a) to d) of the method may be performed within the automatic dishwashing machine or they may be carried out in a container, for example, a bucket. If steps a) to d) are performed out of the washing machine, the person skilled in the art will understand that the method will comprise a step of removing the one or more components of the dishwashing machine to be cleaned and placing them in a container, before step b). It will also comprise a step of placing the one or more components of the dishwashing machine to be cleaned in the dishwashing machine before step e).

The amount of the composition according to the first aspect of the invention that is provided in step a) and applied in step b) may be between 10 g and 1000 g, preferably between 50 g and 750 g, more preferably between 75 g and 500 g, even more preferably between 100 g and 250 g.

Optionally, the method comprises steps d.1) and d.2) which are performed before step e), comprising:
d.1) Loading the dishwashing machine with kitchenware to be cleaned,
d.2) Adding a dishwashing detergent to the dishwashing machine.

It will be understood that when steps d. 1) and d.2) are included in the method, not only the one or more components of the dishwashing machine are cleaned, but also the kitchenware introduced into the machine.

Preferably, the one or more components of the dishwashing machine which are to be cleaned, remain in the machine during one or more of the steps a) to e), more preferably the one or more components remain in the machined during all steps a) to e).

In an embodiment, the invention relates to a method for cleaning one or more components of a dishwashing machine, preferably the filter, comprising the following steps:
a) Providing the composition according to the first aspect of the invention;
   a.1) Optionally removing the one or more components of the dishwashing machine to be cleaned and placing them in a container;
b) Contacting at least part of the one or more components of the dishwashing machine to be cleaned with the composition according to the first aspect of the invention;
c) Adding water until the one or more components of the washing machine to be cleaned are at least partially or completely covered with the water;
d) Waiting for a period of between 1 h to 48 h, preferably between 3 h to 36 h, more preferably between 6 h to 24 h, even more preferably between 12 h to 24 h;
   d.0) Optionally placing the one or more components of the dishwashing machine to be cleaned in the dishwashing machine,
   d. 1) Loading the dishwashing machine with kitchenware to be cleaned,
   d.2) Adding a dishwashing detergent to the dishwashing machine; and
e) Performing a wash cycle in the dishwashing machine, with the one or more components to be cleaned located in the dishwashing machine.
   wherein the one or more components of the dishwashing machine remain in the machine during one or more of the steps a) to e), preferably the one or more components remain in the machined during all steps a) to e).

In a third aspect, the invention relates to a use of the composition according to the first aspect of the invention for cleaning one or more components of a dishwashing machine, preferably the filter.

The foregoing aspects may be freely combined with any of the foregoing aspects disclosed herein. In other words, the embodiments of the invention described herein with respect to any single embodiment shall be taken to apply mutatis mutandis to any other embodiment of the invention described herein.

The invention will be further described, by way of example, with the reference to the following non-limiting embodiments.

### Examples

### Formulations

| | Composition (wt. %) | | | | |
|---|---|---|---|---|---|
| Ingredient | A | B | 1 | 2 | 3 |
| Thickener | 0.25-0.75 | 0 | 0.25-0.75 | 0.25-0.75 | 0.25-0.75 |
| Builder | 30-40 | 5-10 | 5-10 | 5-10 | 5-10 |
| Complexing/ | 1-5 | | | | |
| Sequestering | | | | | |
| agent | | | | | |
| pH modifier | 0.5-1 | 0.75-1.5 | 1.5-3.5 | 1.5-3.5 | 1.5-3.5 |
| Non-ionic | 0.5-5 | 0.5-5 | 0.5-5 | 0.5-5 | 0.5-5 |
| surfactant | | | | | |
| Amylase | 0.2-0.4 | 0.2-0.4 | 0.2-0.4 | 0.2-0.4 | 0.2-0.4 |
| (2 wt. %- | | | | | |
| 5 wt. % | | | | | |
| active amylase) | | | | | |
| Protease | 2.5-3.5 | | 2.5-3.5 | 2.5-3.5 | |
| (2.5 wt. %- | | | | | |
| 10 wt. % | | | | | |
| active protease) | | | | | |
| Cellulase | | 0.5-1 | 0.75-1.0 | 0.25-0.5 | 0.25-0.5 |
| (10 wt. %- | | | | | |
| 20 wt. % | | | | | |
| active cellulase) | | | | | |
| Pectinase | | 0.2-0.4 | | | |
| Licheninase | | 0.2-0.4 | | | |
| Additives | 0-5 | 0-10 | 0-5 | 0-5 | 0-5 |
| Water | q.s. | q.s. | q.s. | q.s. | q.s. |
| pH | 9 | 9 | 4.5 | 4.5 | 4.5 |

In Table 1:
The thickener is Xanthan gum.
The builder is selected from: trisodium citrate, methylglycine diacetic acid sodium salt (MGDA), glutamic-N,N-diacetic acid (GLDA).
The sequestering agent is Tetrasodium salt of 1-Hydroxyethylidene-1,1-diphosphonic acid (HEDP).
The pH modifier is citric acid.
The non-ionic surfactant having the formula R¹(OCH₂CH₂)ₘ(O(CH₃)CHCH₂)ₙOH; wherein R¹ is an aliphatic hydrocarbon radical containing between 12 and 14 carbon atoms; m has an average value of 5, and n has an average value of 4.
The additives are selected from the group consisting of: fragrances, dyes, polymers, preservatives, and combinations thereof.

### Performance Tests

### Filter Cleaning

Several consumer filters were tested by:
a) Removing the filter from the dishwashing machine,
b) Placing the filter in a container and contacting at least part of the filter with the composition to be tested;
c) Adding water to the container until the filter was completely covered with the water;
d) After 18 h, removing the filter from the container and placing it back in the dishwashing machine;
e) Running a wash cycle in the dishwashing machine.

Each composition was tested using at least two consumers filters. These filters were provided by consumers.

The test consisted in observing the filters before and after cleaning. A trained experimenter, before and after the filters were washed, evaluated the performance of the compositions considering the effect they provided, i.e.: no benefit, unacceptable cleaning, good cleaning, and excellent cleaning. The experimenter took the soiled surface of the filter before cleaning and observed if that surface has been cleaned.

The results of the tests are shown in Table 2, and they show the average of the performance of the compositions on at least two filters. In Table 2:
0=no benefit-when less than 20% of the soiled surface of the filter is cleaned.
+=unacceptable cleaning-when between 20% and 70% of the soiled surface of the filter is cleaned.
++=good cleaning-when between 71% and 90% of the soiled surface of the filter is cleaned.
+++=excellent cleaning-more than 90% of the soiled surface of the filter is cleaned.

TABLE 2
Cleaning of machine filters
treated with different compositions

| Composition | Performance |
|---|---|
| A | 0 |
| B | + |
| 1 | +++ |
| 2 | +++ |
| 3 | ++ |

As can be seen in Table 2, the compositions according to the invention, i.e. comprising at least one cellulase and at least an amylase, and having a pH of between 4 and 6, provide good cleaning of dishwashing machine filters (Composition 3). The performance is further improved when at least one protease is added to the enzyme system (Compositions 1 and 2) The performance of the compositions according to the invention is much better than that of compositions comprising enzymes like pectinases and/or having a pH outside the range of 4 to 6 (Compositions A and B).

Hence one or more objects of the present invention are achieved by the present which is further elucidated in the appended claims.

1. A dishwashing machine cleaning composition for cleaning one or more components of a dishwashing machine comprising an enzyme system comprising:
at least one cellulase, and
at least one amylase
wherein the composition has a pH of between 4 and 6, and wherein the composition is substantially free of any pectinase.

2. Dishwashing machine cleaning composition according to claim 1, wherein the at least one cellulase is present in an amount of between 0.001 wt. % and 2 wt. % of active cellulase, based on the total weight of the composition.

3. Dishwashing machine cleaning composition according to claim 1, wherein the at least one amylase is present in an amount of between 0.0001 wt. % and 2 wt. % of active amylase, based on the total weight of the composition.

4. Dishwashing machine cleaning composition according to claim 1, wherein the enzyme system further comprises at least one protease.

5. Dishwashing machine cleaning composition according to claim 4, wherein the enzyme system consists of:
at least one cellulase,
at least one amylase, and
at least one protease.

6. Dishwashing machine cleaning composition according to claim 4, wherein the at least one protease is present in an amount of between 0.005 wt. % and 5 wt. % of active protease, based on the total weight of the composition.

7. Dishwashing machine cleaning composition according to claim 1, wherein the composition further comprises at least one non-ionic surfactant selected from the group consisting of alkoxylated alcohols in which the alkyl chain of the surfactant has between 10 and 18 carbon atoms.

8. Dishwashing machine cleaning composition according to claim 1, wherein the composition is in liquid form and comprises at least 1 wt. % water, based on the total weight of the composition, and/or wherein the composition has a pH of between 4.5 and 5.5.

9. Dishwashing machine cleaning composition according to claim 1, wherein the composition comprises at least one thickener and/or at least one builder.

10. Dishwashing machine cleaning composition according to claim 1, wherein the composition is a dishwashing machine filter cleaning composition.

11. A method for cleaning one or more components of a dishwashing machine, preferably the filter, comprising the following steps:
a) Providing the composition according to claim 1;
b) Contacting at least part of the one or more components of the dishwashing machine to be cleaned with the composition;
c) Adding water until the one or more components of the washing machine to be cleaned are at least partially or completely covered with the water;
d) Waiting for a period of between 1 h to 48 h; and
e) Performing a wash cycle in the dishwashing machine, with the one or more components to be cleaned located in the dishwashing machine.

12. Method according to claim 11, wherein the amount of the composition that is provided in step a) and applied in step b) is between 10 g and 1000 g.

13. Method according to claim 11, comprising steps d.1) and d.2) which are performed before step e), comprising:
d.1) Loading the dishwashing machine with kitchenware to be cleaned,
d.2) Adding a dishwashing detergent to the dishwashing machine.

14. Method according to claim 11, wherein the one or more components of the dishwashing machine to be cleaned remain in the machine during one or more of the steps a) to e).

15. A method for cleaning one or more components of a dishwashing machine, the method comprising the step of:
contacting the one or more components of the dishwashing machine with the composition according to claim 1.

16. The method according to claim 15, wherein the one or more components comprises a filter.

17. The dishwashing machine cleaning composition according to claim 1, wherein at least one of:
the at least one cellulase is present in an amount of between 0.005 wt. % and 1.5 wt. %;
the at least one amylase is present in an amount of between 0.0005 wt. % and 1 wt. %;
the composition is in liquid form and comprises at least 10 wt. % water, based on the total weight of the composition; and/or
wherein the composition has a pH of between 4.5 and 5.5.

18. The dishwashing machine cleaning composition according to claim 1, wherein the composition further comprises at least one non-ionic surfactant selected from the group consisting of ethoxylated alcohols, propoxylated alcohols, ethoxylated/propoxylated alcohols, and mixtures thereof, in which the alkyl chain of the surfactant has between 10 and 18 carbon atoms.

19. The dishwashing machine cleaning composition according to claim 18, wherein the alkyl chain of the surfactant has between 12 and 16 carbon atoms.

20. The method according to claim 11, wherein at least one of:
the amount of the composition that is provided in step a) and applied in step b) is between 50 g and 750 g;
step d) is further defined as waiting for a period of between 3 h to 36 h; and/or
the one or more components remain in the machine during all steps a) to e).
